(19) United States
(12) Patent Application Publication
(10) Pub. No.: US 2020/0153827 A1
(43) Pub. Date: May 14, 2020

(54) REPUTATION TRACKING BASED ON TOKEN EXCHANGE

(71) Applicant: SHAPE SECURITY, INC., Mountain View, CA (US)

(72) Inventor: Daniel Moen, Sunnyvale, CA (US)

(73) Assignee: SHAPE SECURITY, INC., Mountain View, CA (US)

(21) Appl. No.: 16/184,963

(22) Filed: Nov. 8, 2018

(51) Int. Cl. H04L 29/06

(52) U.S. Cl. CPC H04L 63/0884; H04L 63/1441

(57) ABSTRACT

Techniques are provided for reputation tracking based on token exchange. A first token and a second token submitted to an application server from a client computing device are received. The first token includes a first token-generated value. The second token includes a second token reputation value and a second function-generated value generated at the client computing device. The second token is validated by verifying the second function-generated value based on the first function-generated value. A third token is generated that includes a third token reputation value and a third function-generated value. The third function-generated value is generated based on the second function-generated value and at least one secret not available to the client computing device. The third token reputation value is generated based on the second token reputation value.

### FIELD OF THE DISCLOSURE

The present disclosure generally relates to security techniques applicable to client/server systems, and relates more specifically to reputation tracking based on token exchange.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Attackers may use software, often referred to as a “bot”, which imitates a browser by receiving instructions from a web server and autonomously generating requests based on those instructions. For example, a bot may receive a web page, gather data in one or more objects defined in the web page, and generate a request for another web page to gather additional data, as if a user using a browser was requesting a new web page. A bot may generate and send a request with data assigned to one or more parameters that correspond to fields in a web page to simulate a user submitting data to a web server through a browser.

Attackers may use bots to commit many types of unauthorized acts, crimes or computer fraud, such as web site or content scraping, ratings manipulation, fake account creation, reserving rival goods attacks, ballot stuffing attacks, password snooping, vulnerability assessments, brute force attacks, click fraud, denial-of-service (DoS) attacks, bidding wars, and system fingerprinting attacks. As a specific example, a malicious user may cause a bot to quickly reserve products that are being offered for sale through a particular web site.

It is relatively common, for example, for illicit organizations to place malware on client computers (e.g. smartphones, tablets, laptops, or desktops) owned by law-abiding people, such as to control those client computers to carry out illegitimate transactions (e.g., with banks or retailers and using credit card or other financial information of the person who is using the particular computer), or to intercept communications between the client and its user, or between the client and a server from which it is getting information and to which it is providing information. For example, such malware may, using a “man in the middle” attack, generate displays in a web browser that look like the legitimate displays from a bank or retail web site, but that act to induce a user to disclose private information (e.g. bank account or credit card information) that the malware then intercepts and forwards to people who will use the information for gain (e.g. identity theft).

Web server administrators may wish to prevent malicious automated attacks on a site, while allowing legitimate users to use the site as intended. However, determining which requests are generated by a legitimate user using a web browser and a malicious user using a bot may be difficult.

### SUMMARY

The appended claims may serve as a summary of the invention.

### BRIEF DESCRIPTION OF THE DRAWINGS

In the drawings:

FIG. 1 illustrates a computer system that includes a reputation tracking server that performs reputation tracking based on token exchange in an example embodiment;

FIG. 2 illustrates a token submission from a client computing device for reputation tracking in an example embodiment;

FIG. 3 is an activity diagram of a process for token exchange between a client computing device and a reputation tracking server in an example embodiment;

FIG. 4 is an activity diagram of a process for token exchange using an in-line security server configuration in an example embodiment;

FIG. 5 is an activity diagram of a process for token exchange using an out-of-band security server configuration in an example embodiment;

FIG. 6 is a flow diagram of a process for reputation tracking based on token exchange in an example embodiment;

FIG. 7 is a flow diagram of a process for automation detection using reputation tracking based on token exchange in an example embodiment;

FIG. 8 illustrates a computer system upon which an embodiment may be implemented.

While each of the drawing figures illustrates a particular embodiment for purposes of illustrating a clear example, other embodiments may omit, add to, reorder, or modify any of the elements shown in the drawing figures. For purposes of illustrating clear examples, one or more figures may be described with reference to one or more other figures, but using the particular arrangement illustrated in the one or more other figures is not required in other embodiments.

### DETAILED DESCRIPTION

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other does not imply an ordering, timing, or any other characteristic of the referenced items unless otherwise specified; the term “and/or” as used herein refers to and encompasses any and all possible combinations of one or more of the associated listed items; that the terms “comprises” and/or “comprising” specify the presence of stated features, but do not preclude the presence or addition of one or more other features.

### GENERAL OVERVIEW

This document generally describes systems, methods, devices, and other techniques for reputation tracking based on token exchange. A token sequence is used to track a reputation of a client computing device. Tokens are generated and exchanged between the client computing device and a reputation tracking server. Over repeated interactions, the token sequence establishes a provable pattern of behavior of the client computing device.

The client computing device submits a token to a reputation tracking server to prove its reputation. The token may be generated based on input that is verifiable by the reputation tracking server. The reputation tracking server validates the tokens generated by the client computing device, generates the next token in the token sequence, and causes transmission of the next token to the client computing device. The client computing device may then use this token for subsequent actions. In some embodiments, tokens are exchanged with interactions between the client computing device and an application server, such as requests and responses.

A token includes a function-generated value. When a client computing device generates a token, it executes client-side code to generate the expected function-generated value for the client-generated token. For example, the client-side code may apply a function to the function-generated value of a prior token, such as a prior token generated by the reputation tracking server.

The client-side function used to generate the function-generated value is known to the reputation tracking server. The reputation tracking server verifies the work performed by the client computing device by verifying the function-generated value in the client-generated token. An attempt to fabricate a token without executing the appropriate client-side code on the appropriate input may result in an invalid token. In some embodiments, the token sequence is invalidated when a token is found invalid. When a token sequence is invalidated, the client computing device will need to use a new token sequence to re-establish its reputation.

After validating the new token, the reputation tracking server generates a new token that is transmitted to the client computing device for later use. A server-generated token includes a function-generated value that is generated based on a function-generated value of a prior token and at least one secret not known to the client computing device. For example, the at least one secret may include a secret function not known to the client computing device. Alternatively and/or in addition, the secret/s may include a secret key not known to the client computing device. Thus, the client computing device is not able to synthesize a server-generated token from a prior token.

In some embodiments, at least two tokens are submitted by the client computing device in a token exchange. For example, the client computing device may submit the last server-generated token as well as a new client-generated token. The reputation tracking server may validate the submitted tokens by using the function-generated value in the server-generated token to verify the function-generated value in the client-generated token. In some embodiments, the reputation tracking server may audit the entire token sequence or a portion thereof by generating the function-generated values of the token sequence from an earlier point. For example, the reputation tracking server may regenerate the function-generated values for the entire token sequence to verify that a submitted token belongs to a valid token sequence.

In some embodiments, reputation tracking is implemented to detect automated behavior. Tokens in a token sequence are exchanged along with interactions between a client computing device and an application server, such as requests and responses. A token may have a reputation value that corresponds to a history of successful token exchange. A simple example of a reputation value for a particular token in a token sequence is the order that the particular token appears in the token sequence. In this case, the reputation value for a particular token can be generated by incrementing the reputation value of the preceding token.

The tokens may include a reputation value that corresponds to a history of the client computing device submitting non-automated requests to the application server. For example, in some embodiments, a security server may perform other methods of automation detection on requests submitted by a client computing device. In some embodiments, the token sequence is invalidated when it is determined that a particular request is automated, and the client computing device will need to re-establish its reputation in a new token sequence.

In some implementations, the various techniques described herein may achieve one or more of the following advantages: a provider of an application—e.g. a Web application or native application—may better protect its users and itself from fraudsters; the protection may be provided relatively simply for the application provider in certain implementations, such as by simply having the application provider include in its own code a relevant piece of code that it obtains from the security service provider; in particular implementations, such security can be added without the content provider having to install any new hardware or software on its own server systems; the security component code can be provided flexibly by an organization that specializes in web security, which can in turn keep the security component code updated to address ever-changing security threats; such a security organization can also aggregate data received from served security components (e.g. the data that characterizes various clients, along with data that indicates whether they were determined to be legitimate or automated) across many clients that operate many domains, and can use that aggregated information to generate countermeasures that are more effective than countermeasures that could be developed using only data from a single domain. Additional features and advantages are apparent from the specification and the drawings.

### System Overview

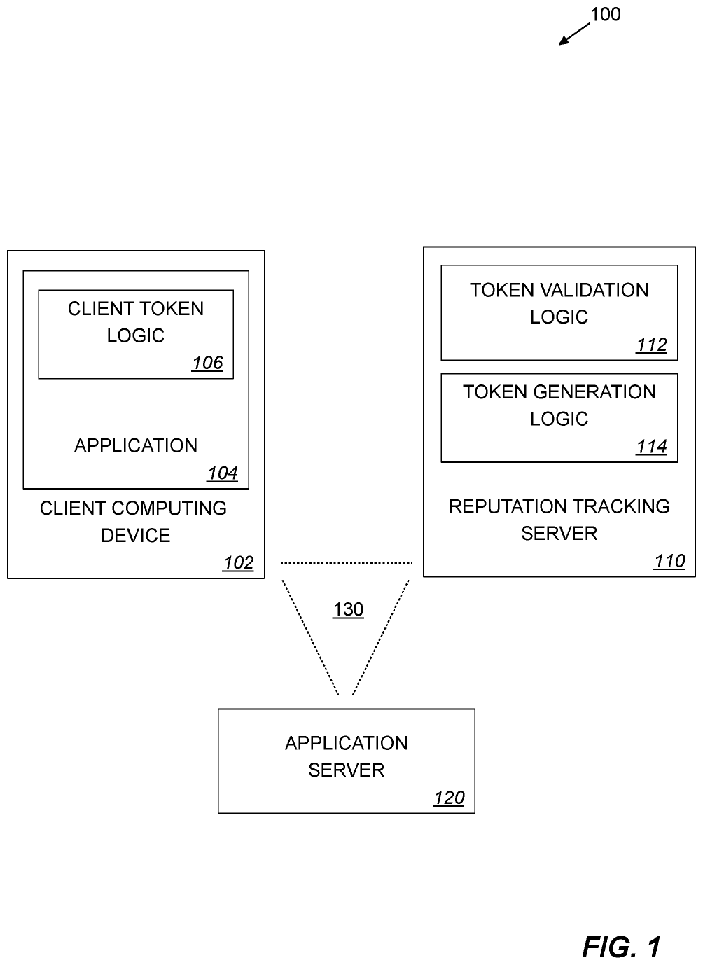

FIG. 1 illustrates a computer system that includes a reputation tracking server that performs reputation tracking based on token exchange in an example embodiment. Computer system 100 includes a client computing device 102, a reputation tracking server 110, and an application server 120. The reputation tracking server 110 and the client computing device 102 generate tokens in a token sequence. The exchange of the tokens in the token sequence allows reputation tracking for the client computing device 102. The computer system 100 may include additional elements, such as a plurality of client computing devices, reputation tracking servers, and/or application servers.

In some embodiments, tokens are exchanged that correspond to interactions between the client computing device 102 and an application server 120, such as requests from the client computing device 102 and responses from the application server 120. Token exchange allows for the tracking of a reputation value that reflects a provable pattern of behavior of the client computing device 102 in its interactions with the application server 120. Token exchange is described in greater detail hereinafter.

As used herein, the term “server” refers to a combination of integrated software components and an allocation of computational resources, such as memory, one or more computing devices, and/or processes on the computing device for executing the integrated software components. The combination of the software and computational resources are dedicated to providing a particular type of function on behalf of clients of the server. A server may refer to either the combination of components on one or more computers, or the one or more computers (also referred to as “server computers”). A server computer may include multiple servers; that is, a server computer may provide a first set of functions on behalf of a first set of clients, and a second set of functions on behalf of a second set of clients.

In some embodiments, the reputation tracking server 110 performs other functions in addition to token exchange for reputation tracking as described herein. For example, the reputation tracking server 110 may be a security server that performs other functionality, including automation detection, as described in greater detail hereinafter.

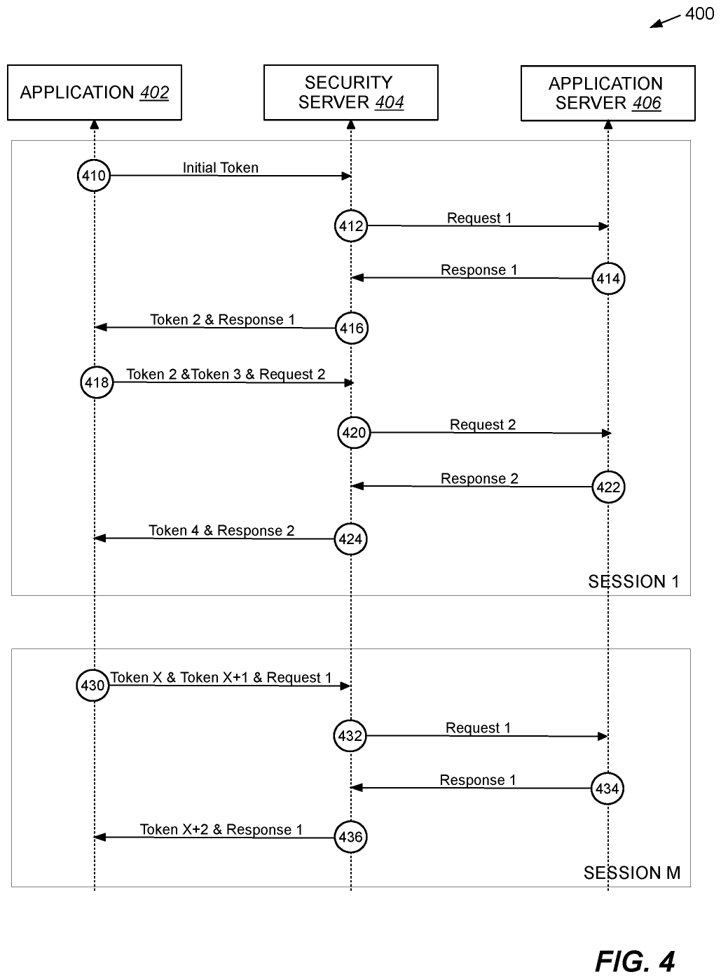

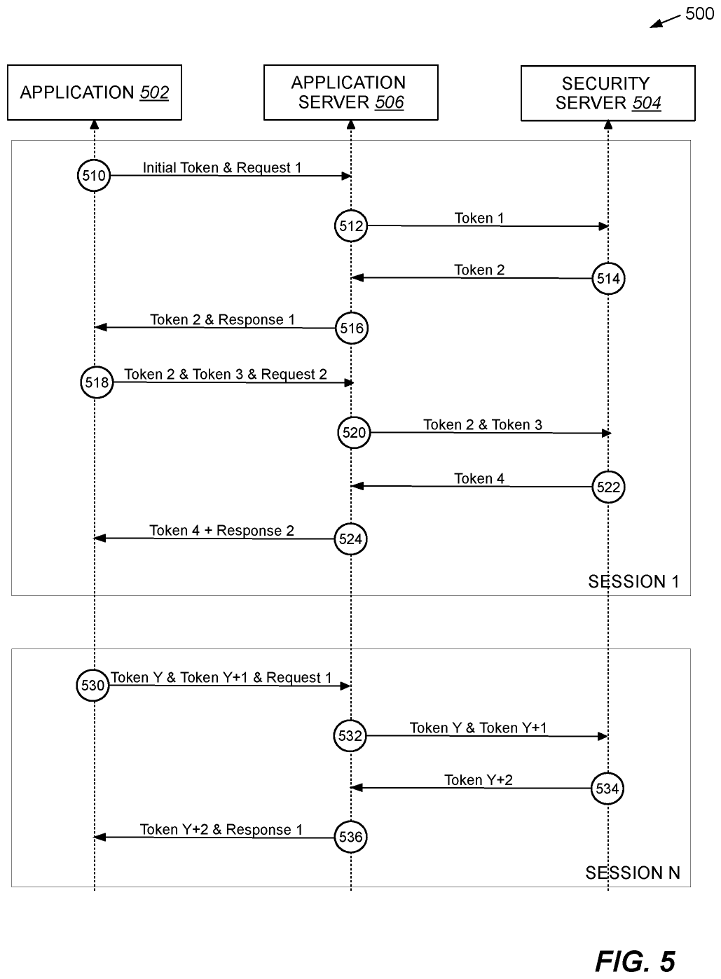

The client computing device 102, the reputation tracking server 110, and/or the application server 120 communicate over one or more networks 130, such as the Internet. The communication paths between components of computer system 100 may differ in different implementations. For example, an example in-line configuration and an example out-of-band configuration of a security server acting as a reputation tracking server are described in greater detail hereinafter at FIG. 4 and FIG. 5, respectively.

In some embodiments, the client computing device 102 executes an application 104 that communicates with the application server 120. Token exchange may be used to track a reputation of the client computing device 102 with respect to the application 104 and/or the application server 120. The application 104 may be a web application that executes in a browser on the client computing device 102, a native application developed for use on a particular platform or device, and/or other applications that may execute on a computing device. In some embodiments, the client computing device 102 is a mobile device that runs a particular device platform, such as the Android platform or the iOS platform, and the application 104 is a native application developed for the respective device platform.

In some embodiments, the application 104 includes client token logic 106. The client token logic 106 causes the client computing device 102 to generate new tokens in the token sequence corresponding to the reputation that is tracked. The client token logic 106 and/or the application 104 may submit one or more client-generated tokens for verification by the reputation tracking server 110.

In some embodiments, the application 104 is generated using a software development kit (SDK) that includes features for incorporating the client token logic 106 in the application 104. For example, a security service provider that operates the reputation tracking server 110 may generate, publish and/or otherwise provide the SDK to third party application developers. The SDK may include libraries and/or code that the developers may integrate with their own application code. In some embodiments, the client token logic 106 is incorporated into and/or downloaded with the application 104, such as via an application store for a particular device platform.

Client-generated tokens may be generated based on input that is verifiable by the reputation tracking server 110. For example, the client token logic 106 may create client-generated tokens based on a preceding token, such as a server-generated token. The client computing device 102 may submit the preceding token with the new client-generated token. In some embodiments, the client token logic 106 creates client-generated tokens using one or more functions that are known to the reputation tracking server 110.

The reputation tracking server 110 includes token validation logic 112 and token generation logic 114. The token validation logic 112 validates client-generated tokens submitted by the client computing device 102. For example, the reputation tracking server 110 may calculate the function-generated value of a client-generated token to verify the work performed by the client computing device 102 in generating the client-generated token using the appropriate client-side code. Token validation is described in greater detail hereinafter.

The token generation logic 114 generates server-generated tokens based on a preceding token, such as a client-generated token submitted by the client computing device 102. The server-generated token may be generated after verifying a client-generated token. The reputation tracking server 110 causes transmission of the server-generated token to the client computing device 102. The client computing device 102 may use the server-generated token in a subsequent submission to prove its reputation. In some embodiments, server-generated tokens are generated based on a preceding client-generated token and at least one secret not available to the client computing device 102, such as a secret function, a secret key, and/or other secret information not available to client computing device 102. Server-generated tokens are described in greater detail hereinafter.

### Token Submission

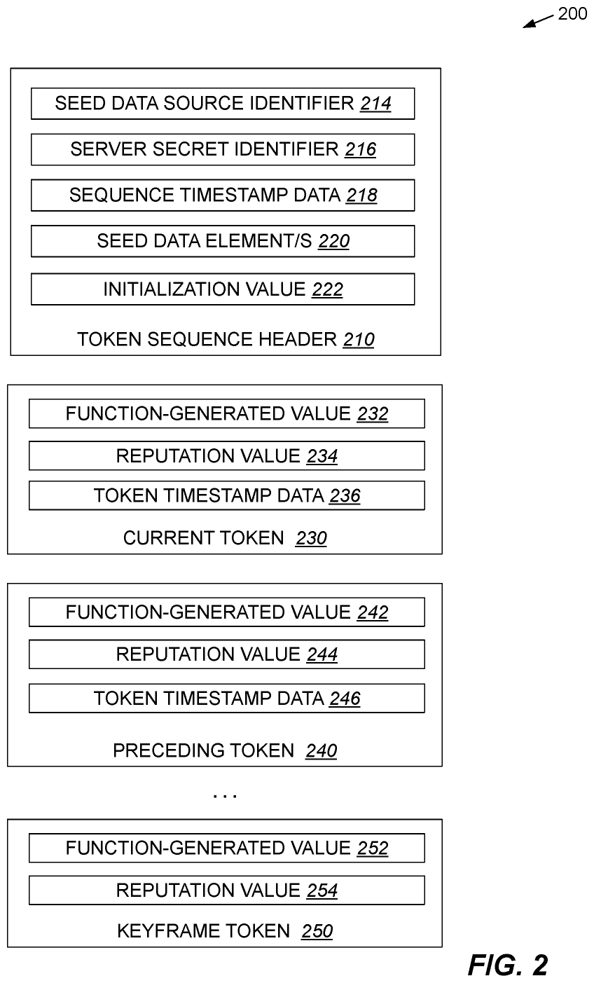

FIG. 2 illustrates a token submission from a client computing device for reputation tracking in an example embodiment. The token submission 200 includes token data that corresponds to a particular token sequence for tracking reputation between a particular client computing device (such as but not limited to client computing device 102) and a particular reputation tracking server (such as but not limited to reputation tracking server 110). In some embodiments, the client computing device 102 submits the token submission 200 when it interacts with the application server 120. For example, the application 104 executing on the client computing device 120 may include a token submission 200 for one or more requests to the application server 120. A token submission 200 may be expected for certain requests to the application server 120, and may be requested for each request in some embodiments.

### Initializing a Token Sequence

In some embodiments, the client token logic 106 is configured to generate an initial token submission to initialize a token sequence for a client computing device 102. When a token sequence is initialized for the client computing device 102, the new token sequence reflects no prior history or existing reputation for the client computing device 102.

A token sequence may be initialized using one or more seed data elements 220. The seed data element/s 220 may include data that is known to the reputation tracking server 110, transmitted to the reputation tracking server 110, and/or verifiable by the reputation tracking server 110. The reputation tracking server 110 may use the seed data element/s 220 to verify the initialization request from the client computing device 102.

In some embodiments, the seed data element/s 220 includes one or more of collected telemetry data, a unique key assigned to the client computing device 102, a unique key assigned to the application 104 executing on the client computing device 102, an IP address of the client computing device 102, an operating system of the client computing device 102, a browser fingerprint of a browser executing on the client computing device 102, and/or or other data unique to the client computing device 102 and/or interactions between the client computing device 102 the application server 120.

### Initialization Value

The initialization value 222 of a token sequence determines the tokens that exist in the token sequence. For example, a unique token sequence can be generated from a combination of a particular initialization value 222, a particular client-side function for creating client-generated tokens, and a particular set of server-side secrets for creating server-generated tokens. In some embodiments, the initialization value 222 of a token sequence is exchanged along with tokens in the token sequence (such as in the header 210). Using the initialization value 222, the reputation tracking server 110 can generate all tokens in the token sequence to verify that a purported token with a purported reputation value and a purported initialization value 222 is a valid token that belongs to the token sequence corresponding to the initialization value 222.

In some embodiments, the client token logic 106 is configured to calculate an initialization value 222 based on the client computing device 102. For example, the initialization value 222 may be a hash value generated by applying a hash function to input comprising the seed data element/s 220.

The reputation tracking server 110 may use the seed data element/s 220 to verify the initialization request from the client computing device 102. When the reputation tracking server 110 receives a request to initialize a token sequence for a client computing device 102, the reputation tracking server 110 may calculate the initialization value 222 based on the seed data element/s 220 to verify the work performed by the client computing device 102 in generating the initialization value 222 using the appropriate client-side code. In some embodiments, an initial token submission is used to begin a token sequence after a particular token sequence involving the client computing device 102 is found invalid.

### Token Sequence Header

A token submission 200 may include a token sequence header 210 that describes one or more properties of the token sequence. The token sequence header may include the seed data element/s 220 used to initialize the token sequence and the initialization value 222 generated based on the seed data element/s 220.

In some embodiments, the token sequence header 210 includes an initialization string comprising the seed data element/s 220 indicated in the seed data source identifier 214. For example, the seed data source identifier 214 may indicate a selection of data sources to be included in the initialization string, and may also indicate an order and format for the seed data element/s 220 in the initialization string. The initialization value 222 may be generated by applying a hash function to the initialization string. The reputation tracking server 110 may use the seed data source identifier 214 to synthesize the initialization string based on data available to the reputation tracking server, such as seed data known to the reputation tracking server 110, transmitted to the reputation tracking server 110 (e.g. in the token sequence header 210), and/or verifiable by reputation tracking server 110.

### Reputation Value

In some embodiments, the token submission 200 includes a current token 230 and a preceding token 240. When the token submission 200 is submitted from a client computing device 102, the current token 230 is a client-generated token and the preceding token 240 is a server-generated token.

In some embodiments, tokens in the token sequence include a reputation value. The reputation value 234 of the current token 230 reflects an up-to-date pattern of behavior of the client computing device 102. For example, the reputation value 234 of the current token may describe a history of interactions between the client computing device 102 and the application server 120 that meet a set of one or more criteria. In some embodiments, the reputation value 234 of a current token 230 indicates that a number of legitimate transactions have occurred between the client computing device 102 and the application server 120. The set of one or more criteria may define what constitutes a legitimate transaction. The reputation value 244 of the preceding token 240 may correspond to a number of legitimate transactions that have occurred as of the token timestamp data 246 corresponding to the time the preceding token 240 was created. A token sequence with many tokens may correspond to a long history of legitimate interactions, indicating an established reputation of the client computing device 102.

The reputation value of future tokens exchanged in the token sequence may increase as subsequent tokens are created. That is, the reputation value 234 of the current token 230 may be greater than the reputation value 244 of the preceding token 240 in the token sequence. In some embodiments, “greater than” with respect to reputation is equivalent to the “>” mathematical operator on numerical values. However, any operator may be defined for comparing reputation values. For example, when the reputation value is decremented with successive tokens, then a lower numerical value would have a reputation value that is greater than a higher numerical value. In some embodiments, the reputation value 234 of the current token 230 is generated by incrementing the reputation value 244 of the preceding 240 token in the sequence such that the reputation value 232 reflects a number of tokens in existence when the current token 230 is generated. The reputation of the client computing device 120, as indicated by the most recent token in the token sequence, increases as more trust is established over the existence of the token sequence.

In some embodiments, reputation tracking based on token exchange is used to detect automated behavior, such as by malicious software executing on the client computing device 102. In this case, the current token 230 may include a reputation value 234 that corresponds to a history of the client computing device 102 submitting non-automated requests to the application server 120. Automation detection using reputation tracking based on token exchange is described in greater detail hereinafter.

### Function-Generated Value in Client-Generated Tokens

In some embodiments, tokens in a token sequence include a function-generated value. When a client computing device 102 generates a token, it executes client-side code, such as client token logic 106, to correctly generate the next token in the token sequence. Since token submission 200 is submitted by the client computing device 102, the preceding token 240 is a server-generated token and the current token 230 is a client-generated token generated by the client computing device 102.

A correctly generated client-generated token includes the expected function-generated value that is verifiable by the token validation logic 112 at the reputation tracking server 110. In some embodiments, the client token logic 106 applies a function that is known to the reputation tracking server 110 to the function-generated value 242 of a preceding server-generated token (e.g. preceding token 240) to create a client-generated token (e.g. current token 230) in the token sequence with the correct function-generated value 232.

The reputation tracking server 110 is able to use the knowledge of the function used by the client token logic 106 to verify the function-generated value 234 of the current token 230 submitted by the client computing device 102, such as by using the function-generated value 242 from the preceding token 240. In some embodiments, a client computing device 102 submits the current token 230 along with one or more preceding tokens 240. The reputation tracking server 110 may then verify the function-generated value 232 of the client-generated token (e.g. current token 230) using the one or more preceding tokens 240.

### Function-Generated Value in Server-Generated Tokens

Server-generated tokens are generated by the reputation tracking server 110. In the token submission 200 from the client computing device 102, the preceding token 240 is a server-generated token. The function-generated value 242 of a server-generated token (e.g. preceding token 240) may be generated based on the function-generated value of a client-generated token, such as a token that immediately precedes preceding token 240 in the token sequence (not shown).

In some embodiments, a server-generated token includes a function-generated value 242 that is generated based on at least one secret not known to the client computing device 102. Thus, the client computing device 102 does not possess code in application 104 or client token logic 106 that could synthesize a server-generated token (e.g. preceding token 240) with the correct function-generated value 242. When at last one secret is used that is not known to the client computing device 102, the client computing device 102 cannot unilaterally generate additional tokens in the token sequence that increase the reputation of the client computing device 102 without verification by the reputation tracking server 110. This, the reputation value 234 of the client computing device 102, as submitted in the current token 230, cannot be increased without verification by the reputation tracking server 110.

In some embodiments, the at least one secret used to generate server-generated tokens may include a secret function not known to the client computing device 102. For example, the reputation tracking server 110 may use a different function to generate the function-generated value of a server-generated token (e.g. preceding token 240) than the client computing device uses to generate the function-generated value of a client-generated token (e.g. current token 230). In some embodiments, the function-generated value 242 is generated by applying a secret function to the function-generated value of a client-generated token (not shown) that precedes token 240.

Alternatively and/or in addition, the at least one secret used to generate server-generated tokens may include a secret key not known to the client computing device 102. For example, the function-generated value 242 may be generated by applying a function (such as but not limited to the secret function) to at least one input generated based the secret key and the function-generated value of a client-generated token (not shown) that precedes token 240. An example of an input generated based on the second function-generated value and the secret key is a string that includes the secret key appended to the function-generated value.

### Sliding Window

One or more examples are given where the preceding token 240 and the current token 230 are submitted in a token submission 200, and the current token 230 is validated based on the preceding token 240. In some embodiments, a token submission 200 includes a sliding window of tokens that includes the last N tokens of the token sequence. In this case, the reputation tracking server 110 may validate the last N−1 tokens based on its preceding token that is included in the token submission 200.

Limited Operation without Server Verification

In some embodiments, a client computing device 102 may be allowed to continue the token sequence, such as when the reputation tracking server 110 and/or the application server 120 are unavailable. For example, one or more transactions submitted when a mobile client computing device 102 loses connectivity may be allowed to proceed without requiring feedback from the reputation tracking server 110. The reputation tracking server 110 may allow such activity on a case-by-case basis. For example, the reputation tracking server 110 may detect excessive token creation without feedback from the reputation tracking server 110.

### Invalidating Tokens

When a token in a token sequence fails validation, the reputation of the client computing device 102 is affected. In some embodiments, the entire token sequence is invalidated when validation fails on a current token 230 of the token sequence.

In some embodiments, the reputation tracking server 110 maintains a blacklist of misused token sequences. For example, the reputation tracking server 110 may use data in the token sequence header 210, such as the initialization value 222 of a token sequence, to implement the blacklist of all tokens in a token sequence generated in the particular token sequence that is based on the initialization value.

In some embodiments, the reputation tracking server 110 maintains a list of suspect token sequences that have not been invalidated. Such token sequences may be blacklisted if additional suspicious activity is detected.

In some embodiments, a group of tokens may be invalidated at once. This may be implemented by using different server secrets for different token sequences. In some embodiments, the token sequence header 210 includes a server secret identifier 216 that identifies an index of one or more secret keys at the server to be used for a particular current token sequence. For example, a particular secret key with a particular index at the reputation tracking server 110 may be used for client computing devices 102 associated with a particular domain, client computing device 102 associated with a particular service level, token sequences initiated during a particular time frame, or by another categorization. If the reputation tracking server 110 finds it necessary to invalidate tokens corresponding to the categorization, the reputation tracking server 110 may invalidate the secret key at the index referred to in the token sequence header 210, thereby invalidating all token sequences that refer to the index of the now-invalid secret key.

### Token Sequence Playback

In some embodiments, additional auditing may be performed by the reputation tracking server. In some embodiments, the reputation tracking server 110 may play back the entire token sequence or a portion thereof by generating data for all tokens in the token sequence based on the token initialization data (e.g. the seed data element/s 220 and the initialization value 220). A playback of the token sequence may be performed online or offline.

In some embodiments, the reputation tracking server 110 regenerates the function-generated values and/or the reputation value 234 for all tokens in the token sequence to verify that a current token 230 submitted by a client computing device 102 is a valid token in the token sequence.

During playback, if the calculated reputation value of a playback token exceeds the reputation value 234 of the current token without the generation of the current token 230, the reputation tracking server 110 may determine that the current token 230 is not a valid token in the token sequence. That is, the purported current token 230 with the purported reputation value 234 and the purported function-generated value 232 does not exist in the token sequence.

In some embodiments, a token submission 200 includes one or more keyframe tokens 250. A partial playback of the token sequence may be performed by using the function-generated value 252 and/or the reputation value 254 of a keyframe token 250 calculate the function-generated value and/or reputation value for intermediate tokens in the token sequence that are ordered between the keyframe token 250 and the current token 230.

### Token Exchange

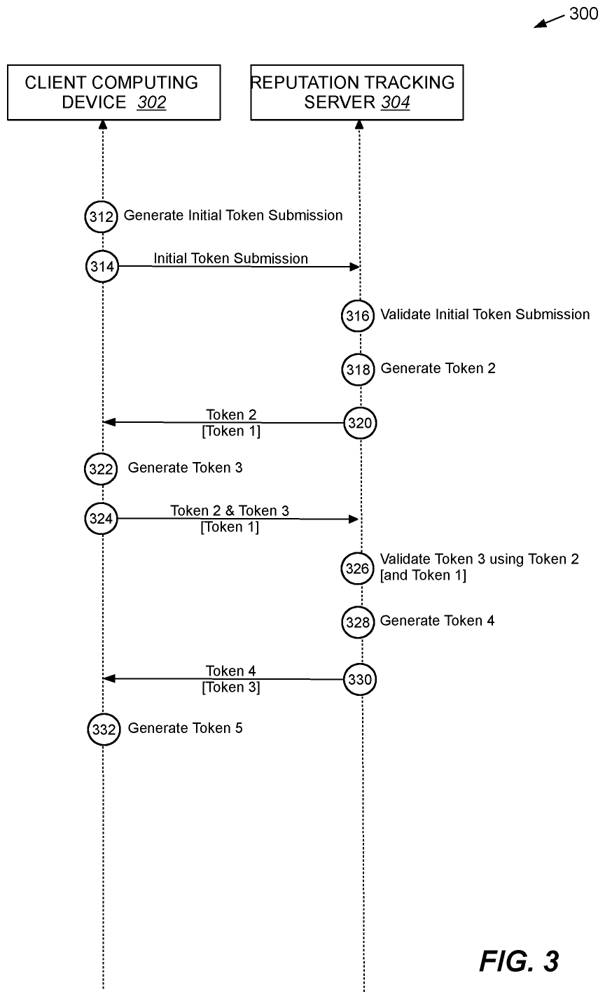

FIG. 3 is an activity diagram of a process for token exchange between a client computing device and a reputation tracking server in an example embodiment. Process 300 involves a client computing device 302 and a reputation tracking server 304.

At 312, the client computing device 302 generates an initial token submission. The initial token submission includes data for initializing a new token sequence for tracking the reputation of the client computing device 302. For example, the initial token submission may include one or more seed data elements 220 and an initialization value 222 generated based on the seed data elements 220. At 314, the client computing device 302 submits the initial token submission, which is received by the reputation tracking server 304. In some embodiments, the initial token submission includes a token sequence header 210 containing the seed data element/s 220 and the initialization value 222.

At 316, the reputation tracking server 304 validates the initial token submission. For example, the reputation tracking server 304 may verify that the initialization value 222 in the initial token submission is correctly generated based on the seed data element/s 220. At 318, if the initial token submission is valid, the reputation tracking server generates Token 2. At 320, the reputation tracking server 304 causes transmission of Token 2 to the client computing device 302.

At 322, the client computing device 322 generates Token 3 based on Token 2. At 324, the client computing device 322 submits Token 3, which is received by the reputation tracking server 304. In some embodiments, the client computing device 302 submits Token 3 in a token submission 200 that includes the token sequence header 210, Token 3, and Token 2.

At 326, the reputation tracking server 304 validates Token 3. For example, the reputation tracking server 304 may verify the function-generated value 232 of Token 3 based on the function-generated value 242 of the preceding token, Token 2. In some embodiments, the reputation tracking server 304 plays back the token sequence by (1) recalculating the function-generated value for all tokens in the sequence using the token sequence header 210 or (2) recalculating the function-generated value for tokens generated after a keyframe token 250 that is included in the token submission 200.

At 328, if the Token 3 is valid, the reputation tracking server 304 generates Token 4. At 330, the reputation tracking server 304 causes transmission of Token 4 to the client computing device 302.

If any token is found invalid by the reputation tracking server 304, process 300 does not proceed. In some embodiments, the reputation tracking server 304 invalidates all tokens in the token sequence. The client computing device 302 must initialize another token sequence when future token submissions are required.

### Abnormal Interaction Rate

In some embodiments, the token sequence is used to evaluate a rate of interactions. For example, when token exchange is used detect automation, a high rate of interactions may indicate autonomous behavior. Generally, bots submit automated requests at a much higher rate compared to requests that are initiated by legitimate human interaction with an application 104. In some embodiments, during token exchange, the reputation tracking server 110 may uses the tokens to evaluate a rate of interactions between the client computing device 102 and the application server 120.

In some embodiments, the reputation value 234 of the current token 230 in a token submission 200 reflects a number of interactions between the client computing device 102 and the application server 120 since the token sequence was initialized. For example, the reputation value 234 of the current token 230 is approximately twice the number of transactions when (1) the reputation value of a token reflects a token count at the time the token was created and (2) a token is generally created for each request and each response.

The amount of time the token has been in use can be calculated from the time the current token 230 was created (e.g. the token timestamp data 236 of current token 230) and the time that the token sequence was initialized (e.g. the sequence timestamp data 218 from the token sequence header 210). Thus, the rate of transactions can be estimated for the client computing device 102.

When the token data indicates a high transaction rate, the security server may flag the request as suspicious. In some embodiments, the security server may perform an increased amount of analysis on the request, perform a partial or full audit of the token sequence in real time, perform a partial or full audit of the token sequence offline, generate a record of the suspicious activity, notify the application server, perform another remedial action, and/or any combination thereof.

### Other Suspicious Token Usage

Abnormal interaction rate is one example of suspicious token usage that may be flagged. In some embodiments, other patterns of suspicious token usage are identified. When suspicious token usage is identified, the security server may perform an increased amount of analysis on the request, perform a partial or full audit of the token sequence in real time, perform a partial or full audit of the token sequence offline, generate a record of the suspicious activity, notify the application server, perform another remedial action, and/or any combination thereof.

In some embodiments, suspicious token usage includes the repeated submission of an initial token submission to initialize a token sequence. For example, automated software may attempt to bypass the submission of a client-generated token that is generated based on a server-generated token by submitting repeated initial token submissions. In some embodiments, the security server may apply a rate limit to initial token submissions submitted by a particular client computing device 102 and/or application 104 executing on the client computing device 102. Alternatively and/or in addition, the security server may apply a global rate limit to initial token submissions submitted by any client computing device and/or application.

Tokens may also be evaluated for abnormal timestamp data. For example, an initial token submission may include a purported sequence timestamp data 218 that in the past, such as to create a token sequence that has allegedly existed for a longer time period.

### Automation Detection

In some embodiments, reputation tracking based on token exchange is used to detect automated behavior. Tokens in a token sequence are exchanged along with interactions between a client computing device and an application server, such as requests and responses. The tokens may include a reputation value that corresponds to a history of the client computing device submitting non-automated requests to the application server. For example, in some embodiments, a security server may perform other methods of automation detection on requests submitted by a client computing device. In some embodiments, the token sequence is invalidated when it is determined that a particular request is automated (e.g. based on the other methods of automation detection), and the client computing device will need to re-establish its reputation in a new token sequence.

In some embodiments, a security server performs reputation tracking based on token exchange. The security server may implement other automation detection functionality to evaluate the interactions by the client computing device with the application server. For example, the security server may analyze telemetry data that is collected at the client computing device to determine whether a request or other interaction from the client computing device is automated. For example, a bot executing on the client computing device may attempt malicious interactions with the application server. Alternatively and/or in addition, a bot may attempt to emulate the client computing device when interacting with the application server. When a particular request is determined to be non-automated, the security server continues to exchange tokens in the token sequence with the client computing device, thereby tracking an increase in the reputation of the client computing device.

When tokens exchanged by the client computing device indicate a high reputation value corresponding to an established history of non-automated interactions, the security server may perform a reduced amount of telemetry analysis on the request submitted with the tokens. The sufficient reputation value indicates a sufficient history of interactions with the client computing device where malicious and/or automated behavior was not detected.

### In-Line Security Server

FIG. 4 is an activity diagram of a process for token exchange using an in-line security server configuration in an example embodiment. Process 400 involves a client-side application 402, a security server 404, and an application server 406. The security server 404 is positioned in the network as an in-line device. In the in-line security server configuration, requests from the application 402 are transmitted to the security server 404, which forwards valid requests for processing by the application server 406.

At 410, the application 402 submits an initial token submission, Token 1, along with a first request in a first session. At 412, the in-line security server 404 receives and processes the initial token submission and the first request. If the initial token submission is valid, the security server 404 sends the first request to the application server 406. At 414, the application server 406 sends a first response to the first request to the security server 404. At 416, the security server 404 forwards the first response to the application 402 along with the next server-generated token in the sequence, Token 2.

At 418, the application 402 submits a second request along with Token 2 and a new client-generated token, Token 3 in the first session. At 420, the in-line security server 404 receives the data and validates Token 3. If Token 3 is valid, the security server 404 sends the second request to the application server 406. At 422, the application server 406 sends a second response to the second request to the security server 404. At 424, the security server 404 forwards the first response to the application 402 along with the next server-generated token in the sequence, Token 4.

Token exchange may persist across sessions. At 430, in session M, the application 402 submits a first request of session M along with a new client-generated token, Token X+1, and the preceding server-generated token, Token X. At 432, the in-line security server 404 receives the data and validates Token X+1. If Token X+1 is valid, the security server 404 sends the first request of session M to the application server 406. At 434, the application server 406 sends a first response of session M to the security server 404. At 436, the security server 404 forwards the first response of session M first response to the application 402 along with the next server-generated token in the sequence, Token X+2.

If any token is found invalid by the security server 404, process 400 does not proceed. In some embodiments, the security server 404 invalidates all tokens in the token sequence and the application 402 must initialize another token sequence.

### Out-of-Band Security Server

FIG. 5 is an activity diagram of a process for token exchange using an out-of-band security server configuration in an example embodiment. Process 500 involves a client-side application 502, a security server 504, and an application server 506. The security server 504 is positioned in the network as an out-of-band device. In the out-of-band security server configuration, requests from the application 502 are transmitted to the application server 506, which communicates with security server 504 to perform reputation tracking functionality.

At 510, the application 502 submits an initial token submission, Token 1, along with a first request in a first session. At 512, the application server 506 receives the data and forwards the initial token submission to the security server 504. At 514, the security server 504 validates the initial token submission—if the initial token submission is valid, the security server 504 generates the next server-generated token, Token 2, and transmits Token 2 to the application server 506. At 516, the application server 506 generates the first response if the validation of Token 1 is successful and transmits the first response to the application 502 along with Token 2.

At 518, the application 502 generates the next client-generated token, Token 3, and submits Token 2 and Token 3 token along with a second request. At 520, the application server 506 receives the data and forwards Token 2 and Token 3 to the security server 504. At 522, the security server 504 validates Token 3—if Token 3 is valid, the security server 504 generates the next server-generated token, Token 4, and transmits Token 4 to the application server 506. At 524, the application server 506 generates the second response if the validation of Token 3 is successful, and transmits the second response to the application 502 along with Token 4.

At 530, in session N, the application 502 submits a first request of session N along with a new client-generated token, Token Y+1, and the preceding server-generated token, Token Y. At 532, the security application server 506 receives the data and forwards Token Y and Token Y+1 to the security server 504. At 534, the security server 504 validates token Y+1. At 534, if Token validates Token X+1—f Token X+1 is valid, the security server 504 generates the next server-generated token, Token Y+2, and transmits Token Y+2 to the application server 506. At 536, the application server 506 generates the first response in session N if the validation of Token Y+1 is successful, and transmits the first response in session N to the application 502 along with Token Y+2.

If any token is found invalid by the security server 504, process 500 does not proceed. In some embodiments, the security server 504 invalidates all tokens in the token sequence and the application 502 must initialize another token sequence.

In some embodiments, a system including multiple security servers handles requests corresponding to the in-line security server configuration as well as requests corresponding to the out-of-band security server configuration. For example, the system may include one or more in-line security servers and one or more out-of-band security servers. Alternatively and/or in addition, the system may include a security server that is capable of handling both requests corresponding to the in-line security server configuration as well as requests corresponding to the out-of-band security server configuration.

### Example Processes

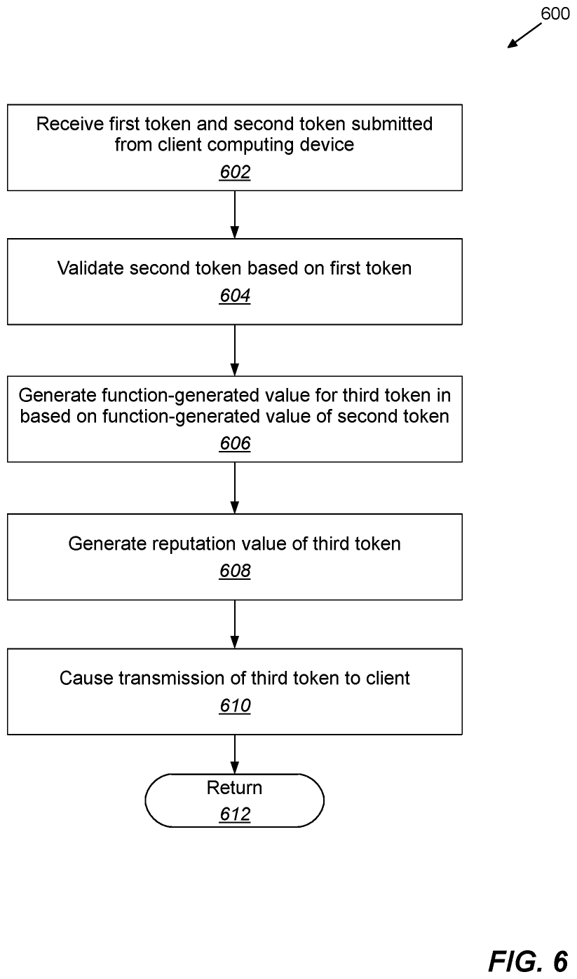

FIG. 6 is a flow diagram of a process for reputation tracking based on token exchange in an example embodiment. Process 600 may be performed by one or more computing devices and/or processes thereof. For example, one or more blocks of process 600 may be performed by computer system 800. In some embodiments, one or more blocks of process 600 are performed by a reputation tracking server executing on one or more server computing devices, such as reputation tracking server 110. Process 600 will be described with respect to reputation tracking server 110, client computing device 102, and application server 120, but is not limited to performance by a reputation tracking server 110.

At block 602, the reputation tracking server 110 receives a first token and a second token submitted to the application server 120 from the client computing device 102. The second token includes a second function-generated value generated at the client computing device 102 and a second token reputation value. The first token and the second token belong to a token sequence that is used to track a reputation of the client computing device 102. Tokens in the token sequence may correspond to interactions between the application server 120 and a corresponding application 104 executing on the client computing device 102. In some embodiments, the reputation value of tokens in the token sequence correspond to a number and/or order of transactions between application 205 executing on the client computing device 102 and the application server 120.

At block 604, the reputation tracking server 110 validates the second token by verifying the second function-generated value based on the first function-generated value. For example, the reputation tracking server 110 may have knowledge of the how the application 104 generates a token at the client computing device 102 based on a token generated by the reputation tracking server 110. The reputation tracking server 110 may verify, based on such knowledge, that the second token was correctly generated from the first token and belongs in the token sequence corresponding to the reputation of the client computing device 102.

At block 606, the reputation tracking server 110 generates a third function-generated value for a third token. The reputation tracking server 110 generates the third function-generated value based on the second function-generated value of the second token submitted by the client computing device 102 and at least one secret not available to the client computing device 102. For example, the reputation tracking server 110 may use a secret function not available to the client computing device 102 to generate the third function-generated value, such as by applying the secret function to the second function-generated value or to other input/s generated based on the second function-generated value. Alternatively and/or in addition, the reputation tracking server 110 may generate the third function-generated value based on a secret key not available to the client computing device 102. For example, the reputation tracking server 110 may apply a function (such as but not limited to a secret function) to one or more inputs generated based on the second function-generated value and a secret key.

At block 608, the reputation tracking server 110 generates a third token reputation value for the third token. The reputation tracking server 110 generates the third token reputation value of based on the second token reputation value of the second token submitted by the client computing device 102. In some embodiments, the third token reputation value indicates that an additional interaction has successfully occurred between the application server 120 and the application executing on the client computing device 102.

At block 610, the reputation tracking server 110 causes transmission of the third token to a client computing device. The client computing device 102 may later submit the third token in the token sequence to prove its reputation. For example, the client computing device 102 may later submit the third token with a subsequent request or other interaction with the application server 120.

At block 612, process 600 returns and/or terminates. For example, process 600 may pass control to a calling process, generate any appropriate record or notification, return after a method or function invocation, process another operation involving the client computing device 102, process an operation involving another client computing device, or terminate.

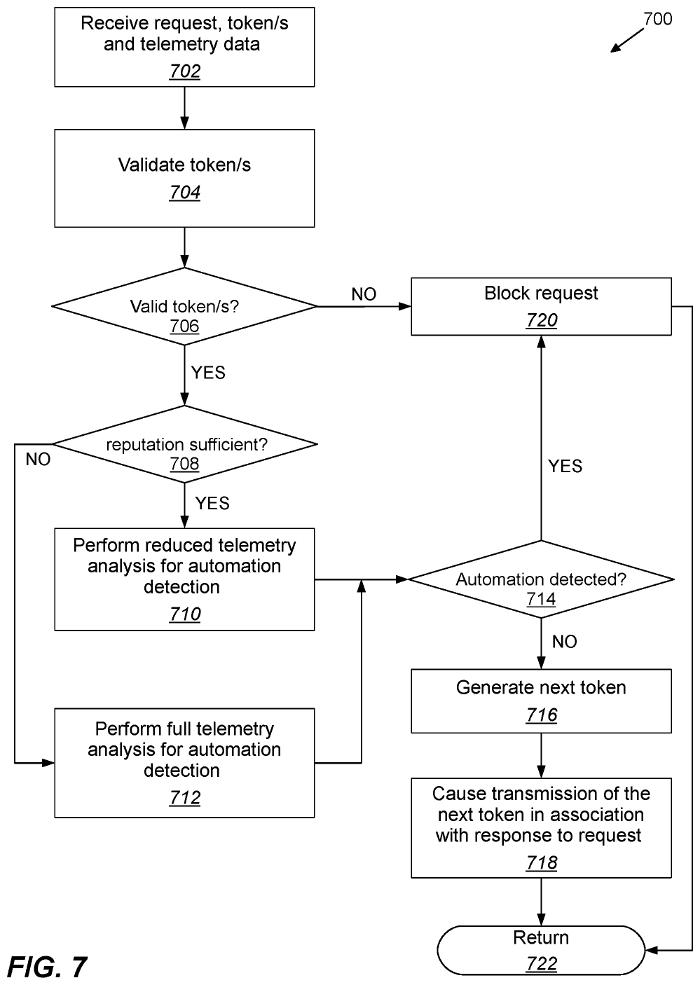

FIG. 7 is a flow diagram of a process for automation detection using reputation tracking based on token exchange in an example embodiment. Process 700 may be performed by one or more computing devices and/or processes thereof. For example, one or more blocks of process 700 may be performed by computer system 800. In some embodiments, one or more blocks of process 700 are performed by a security server executing on one or more server computing devices, such as security server 404 and/or security server 504. Process 700 will be described with respect to a security server, but is not limited to performance by a security server.

At block 702, the security server receives a request, at least one token, and telemetry data from a client computing device. The security server is configured to analyze the telemetry data to detect automated behavior at the client computing device. For example, the security server may use telemetry data submitted with a request from a client computing device to determine whether the request was generated by automated malicious software executing at the client computing device.

At block 704, the security server validates the token/s. For example, the security server may validate the tokens received by calculating and verifying one or more function-generated values of the token/s.

At decision block 706, the security server determines whether the token/s submitted from the client computing device are valid, such as by validating the token/s at block 704. When the token/s are not valid, processing continues to block 720, where the request is blocked. Otherwise, processing continues to decision block 708.

At decision block 708, the security server evaluates the reputation value of the token/s submitted by the client computing device. For example, the security server may determine whether the reputation value of the most recent token of the token/s submitted indicates a sufficient level of trust. In some embodiments, the reputation value corresponds to a history of interactions (e.g. requests, responses) between an application server and an application executing on the client computing device, where malicious and/or automated behavior was not detected at the client computing device with respect to the interactions.

When the security server determines that the reputation value is sufficient, processing continues to block 710. At block 710, the security server performs a reduced amount of telemetry analysis for automation detection. The sufficient reputation value indicates a sufficient history of interactions with the client computing device where malicious and/or automated behavior was not detected. Thus, the reduced amount of analysis is performed for the current request due to the sufficient reputation value.

Returning to decision block 708, when the security server determines that the reputation value is not sufficient, processing continues to block 712. At block 712, the security server performs a full amount of telemetry analysis for automation detection.

At decision block 714, the security server determines whether automation was detected corresponding to the request, such as based on the analysis of the telemetry data submitted with the request. The determination may be made based on other information available to the security server other than the telemetry data. When the security server determines that automation is detected, processing continues to block 720, where the request is blocked. Otherwise, processing continues to block 716.

At block 716, the security server generates the next token in the token sequence. The security server may generate a reputation value of the next token based on the reputation value of the most recent token submitted by the client computing device.

At block 718, the security server causes transmission of the next token to the client computing device in association with a response to the request submitted by the client computing device and received at block 702. The client computing device may later submit the next token in the token sequence to prove its reputation. In some embodiments, the security server causes transmission of one or more additional tokens that may be required for the client computing device to verify its reputation.

At block 722, process 700 returns and/or terminates. For example, process 700 may pass control to a calling process, generate any appropriate record or notification, return after a method or function invocation, process another operation involving the client computing device, process an operation involving another client computing device, or terminate.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field programmable gate arrays (FPGAs) that are persistently programmed to perform the techniques. Alternatively and/or in addition, the one or more special-purpose computing devices may include one or more general purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices and/or any other device that incorporates hard-wired or program logic to implement the techniques.

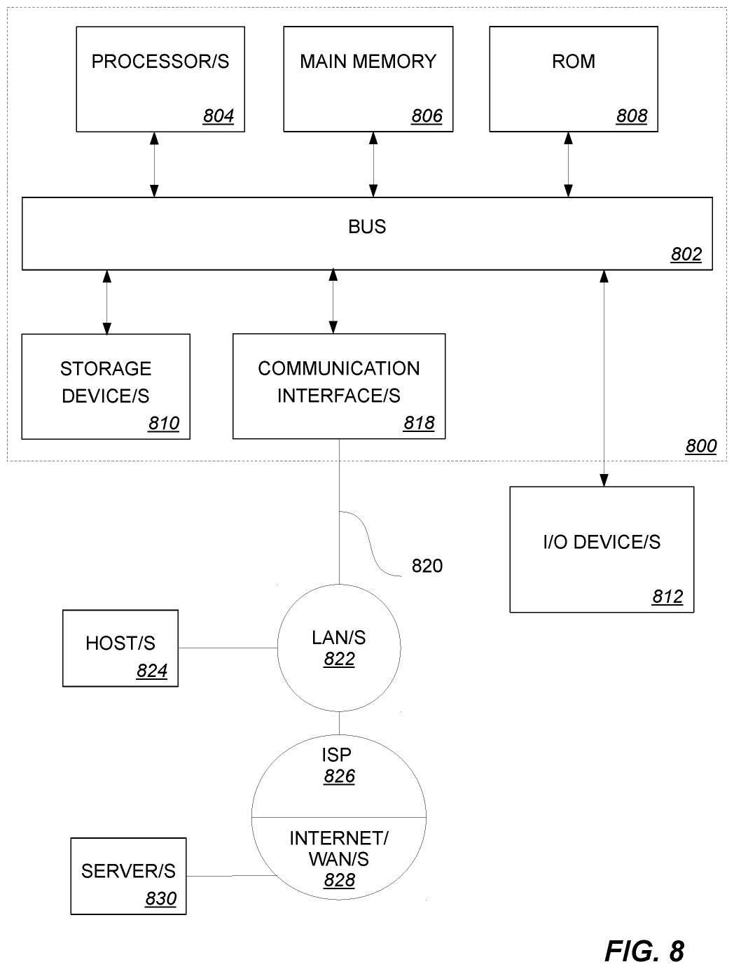

For example, FIG. 8 is a block diagram that illustrates a computer system 800 upon which an embodiment of the invention may be implemented. Computer system 800 includes a bus 802 or other communication mechanism for communicating information, and one or more hardware processors 804 coupled with bus 802 for processing information, such as basic computer instructions and data. Hardware processor/s 804 may include, for example, one or more general-purpose microprocessors, graphical processing units (GPUs), coprocessors, central processing units (CPUs), and/or other hardware processing units.

Computer system 800 also includes one or more units of main memory 806 coupled to bus 802, such as random access memory (RAM) or other dynamic storage, for storing information and instructions to be executed by processor/s 804. Main memory 806 may also be used for storing temporary variables or other intermediate information during execution of instructions to be executed by processor/s 804. Such instructions, when stored in non-transitory storage media accessible to processor/s 804, turn computer system 800 into a special-purpose machine that is customized to perform the operations specified in the instructions. In some embodiments, main memory 806 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

Computer system 800 may further include one or more units of read-only memory (ROM) 808 or other static storage coupled to bus 802 for storing information and instructions for processor/s 804 that are either always static or static in normal operation but reprogrammable. For example, ROM 808 may store firmware for computer system 800. ROM 808 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 810, such as a magnetic disk or optical disk, is provided and coupled to bus 802 for storing information and/or instructions. Storage device/s 810 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid state drives, flash memory, optical disks, one or more forms of non-volatile random access-memory (NVRAM), and/or other non-volatile storage media.

Computer system 800 may be coupled via bus 802 to one or more input/output (I/O) devices 812. For example, I/O device/s 812 may include one or more displays for displaying information to a computer user, such as a cathode ray tube (CRT) display, a Liquid Crystal Display (LCD) display, a Light-Emitting Diode (LED) display, a projector, and/or any other type of display.

I/O device/s 812 may also include one or more input devices, such as an alphanumeric keyboard and/or any other key pad device. The one or more input devices may also include one or more cursor control devices, such as a mouse, a trackball, a touch input device, or cursor direction keys for communicating direction information and command selections to processor 804 and for controlling cursor movement on another I/O device (e.g. a display). This input device typically has at degrees of freedom in two or more axes, (e.g. a first axis x, a second axis y, and optionally one or more additional axes z . . . ), that allows the device to specify positions in a plane. In some embodiments, the one or more I/O device/s 812 may include a device with combined I/O functionality, such as a touch-enabled display.

Other I/O device/s 812 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with processor/s 804 over bus 802.

Computer system 800 may implement the techniques described herein using customized hard-wired logic, one or more ASICs or FPGAs, firmware or program logic which, in combination with the computer system causes or programs, causes computer system 800 to be a special-purpose machine. According to one embodiment, the techniques herein are performed by computer system 800 in response to processor/s 804 executing one or more sequences of one or more instructions contained in main memory 806. Such instructions may be read into main memory 806 from another storage medium, such as one or more storage device/s 810. Execution of the sequences of instructions contained in main memory 806 causes processor/s 804 to perform the process steps described herein. In alternative embodiments, hard-wired circuitry may be used in place of or in combination with software instructions.

Computer system 800 also includes one or more communication interfaces 818 coupled to bus 802. Communication interface/s 818 provide two-way data communication over one or more physical or wireless network links 820 that are connected to a local network 822 and/or a wide area network (WAN), such as the Internet. For example, communication interface/s 818 may include an integrated services digital network (ISDN) card, cable modem, satellite modem, or a modem to provide a data communication connection to a corresponding type of telephone line. Alternatively and/or in addition, communication interface/s 818 may include one or more of: a local area network (LAN) device that provides a data communication connection to a compatible local network 822; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network access a wide area network (WAN, such as the Internet 828); and other networking devices that establish a communication channel between computer system 800 and one or more LANs 822 and/or WANs.

Network link/s 820 typically provides data communication through one or more networks to other data devices. For example, network link/s 820 may provide a connection through one or more local area networks 822 (LANs) to one or more host computers 824 or to data equipment operated by an Internet Service Provider (ISP) 826. ISP 826 in turn provides connectivity to one or more wide area networks 828, such as the Internet. LAN/s 822 and WAN/s 828 both use electrical, electromagnetic or optical signals that carry digital data streams. The signals through the various networks and the signals on network link/s 820 and through communication interface/s 818 are example forms of transmission media, or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire and fiber optics, including traces and/or other physical electrically conductive components that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its main memory 806 and send the instructions over a telecommunications line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 can send messages and receive data, including program code, through the network(s), network link 820 and communication interface 818. In the Internet example, one or more servers 830 might transmit signals corresponding to data or instructions requested for an application program executed by the computer system 800 through the Internet 828, ISP 826, local network 822 and a communication interface 818. The received signals may include instructions and/or information for execution and/or processing by processor/s 804. Processor/s 804 may execute and/or process the instructions and/or information upon receiving the signals by accessing main memory 806, or at a later time by storing them and then accessing them from storage device/s 810.

### OTHER ASPECTS OF DISCLOSURE

Using the networked computer arrangements, intermediary computer, or processing methods described herein, security in client-server data processing may be significantly increased. Polymorphic techniques discussed herein effectively reduce automated attacks. Consequently, one or more various attacks, such as a denial of service (“DOS”) attack, credential stuffing, fake account creation, ratings or results manipulation, man-in-the-browser attacks, reserving rival goods or services, scanning for vulnerabilities, or exploitation of vulnerabilities, are frustrated because object identifiers or polymorphic hooks may change over time.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer system comprising:
one or more hardware processors;
at least one memory coupled to the one or more hardware processors and storing one or more instructions which, when executed by the one or more hardware processors, cause the one or more hardware processors to:
receive a first token and a second token submitted to an application server from a client computing device, the first token comprising a first function-generated value, the second token comprising a second function-generated value generated at the client computing device;
validate the second token by verifying the second function-generated value based on the first function-generated value;
when the second token is valid, generate a third token of a token sequence comprising the first token and the second token by:
generate a third function-generated value for the third token based on the second function-generated value and at least one secret not available to the client computing device; and
generate a reputation value for the third token that is greater than a reputation value for the second token; and
cause transmission of the third token to the client computing device;

2. The computer system of claim 1, wherein the one or more instructions, when executed by the one or more hardware processors, cause the one or more processors to:

2. The computer system of claim 1, wherein the reputation value of a particular token in the token sequence corresponds to an order of the particular token in the token sequence.

3. The computer system of claim 1, wherein the one or more instructions, when executed by the one or more hardware processors, cause the one or more processors to:
generate the first token by generating the first function-generated value based on the at least one second secret not available to the client computing device; and
cause transmission of the first token to the client computing device.

4. The computer system of claim 1, wherein the one or more instructions, when executed by the one or more hardware processors, cause the one or more processors to:
receive an initial token submission submitted by the client computing device, the initial token submission identifying at least one seed data element and an initialization value generated at the client computing device based on the at least one seed data element;
validate the initial token submission by verifying the at least one seed data element and the initialization value;
generate the first token by generating the first function-generated value based on the initialization value and the at least one secret not available to the client computing device; and
cause transmission of the first token to the client computing device.

5. The computer system of claim 1, wherein the one or more instructions, when executed by the one or more hardware processors, cause the one or more processors to:
receive, in association with the first token and the second token, an initialization value for the token sequence;
wherein validating the second token comprises, based on the initialization value, calculating function-generated values for all tokens in the token sequence with a reputation value less than or equal to the reputation value of the second token to verify that the second token belongs in the token sequence.

6. The computer system of claim 5, wherein calculating the function-generated values includes generating one or more function-generated values for one or more client-generated tokens using a client-side function and generating one or more function-generated values for one or more server-generated tokens using the at least one secret not available to the client computing device.

7. The computer system of claim 1, wherein the one or more instructions, when executed by the one or more hardware processors, cause the one or more processors to:
receive, in association with the first token and the second token, a keyframe token in the token sequence;
wherein validating the second token comprises, based on the keyframe token, calculating function-generated values for all tokens in the token sequence with a reputation value between a reputation value of the keyframe token and the reputation value of the second token to verify that the second token belongs in the token sequence.

8. The computer system of claim 1, wherein tokens in the token sequence are exchanged in association with transactions between the application server and an application executing on the client computing device.

9. The computer system of claim 1, wherein a reputation value of a particular token in the token sequence is higher than a reputation value of any token preceding the particular token in the token sequence.

10. The computer system of claim 1:
wherein the at least one secret includes a secret function not known to the client computing device;
wherein generating the third function-generated value includes applying the secret function to at least one input generated based on the second function-generated value.

11. The computer system of claim 1:
wherein the at least one secret includes a secret key not known to the client computing device;
wherein generating the third function-generated value includes applying a function to at least one input generated based on the second function-generated value and the secret key.

12. The computer system of claim 1, wherein the one or more instructions, when executed by the one or more hardware processors, cause the one or more processors to:
receive, in association with the first token and the second token, a request generated at the client computing device and telemetry data generated at the client computing device in association with the request;
evaluate the telemetry data to detect automation involved in generating the request;
wherein generating the third token occurs only when automation is not detected.

13. A method comprising:
receiving a first token and a second token submitted to an application server from a client computing device, the first token comprising a first function-generated value, the second token comprising a second function-generated value generated at the client computing device;
validating the second token by verifying the second function-generated value based on the first function-generated value;
when the second token is valid, generating a third token of a token sequence comprising the first token and the second token by:
generating a third function-generated value for the third token based on the second function-generated value and at least one secret not available to the client computing device; and
generating a reputation value for the third token that is greater than a reputation value for the second token; and
causing transmission of the third token to the client computing device;
wherein the method is performed by one or more processors.

14. The method of claim 13, wherein the reputation value of a particular token in the token sequence corresponds to an order of the particular token in the token sequence.

15. The method of claim 13, further comprising:
generating the first token by generating the first function-generated value based on the at least one second secret not available to the client computing device; and
causing transmission of the first token to the client computing device.

16. The method of claim 13, further comprising:
receiving an initial token submission submitted by the client computing device, the initial token submission identifying at least one seed data element and an initialization value generated at the client computing device based on the at least one seed data element;
validating the initial token submission by verifying the at least one seed data element and the initialization value;
generating the first token by generating the first function-generated value based on the initialization value and the at least one secret not available to the client computing device; and
causing transmission of the first token to the client computing device.

17. The method of claim 13, further comprising:
receiving, in association with the first token and the second token, an initialization value for the token sequence;
wherein validating the second token comprises, based on the initialization value, calculating function-generated values for all tokens in the token sequence with a reputation value less than or equal to the reputation value of the second token to verify that the second token belongs in the token sequence.

18. The method of claim 17, wherein calculating the function-generated values includes generating one or more function-generated values for one or more client-generated tokens using a client-side function and generating one or more function-generated values for one or more server-generated tokens using the at least one secret not available to the client computing device.

19. The method of claim 13, further comprising:
receiving, in association with the first token and the second token, a keyframe token in the token sequence;
wherein validating the second token comprises, based on the keyframe token, calculating function-generated values for all tokens in the token sequence with a reputation value between a reputation value of the keyframe token and the reputation value of the second token to verify that the second token belongs in the token sequence.

20. The method of claim 13, wherein tokens in the token sequence are exchanged in association with transactions between the application server and an application executing on the client computing device.

21. The method of claim 13, wherein a reputation value of a particular token in the token sequence is higher than a reputation value of any token preceding the particular token in the token sequence.

22. The method of claim 13:
wherein the at least one secret includes a secret function not known to the client computing device;
wherein generating the third function-generated value includes applying the secret function to at least one input generated based on the second function-generated value.

23. The method of claim 13:
wherein the at least one secret includes a secret key not known to the client computing device;
wherein generating the third function-generated value includes applying a function to at least one input generated based on the second function-generated value and the secret key.

24. The method of claim 13, further comprising:
receiving, in association with the first token and the second token, a request generated at the client computing device and telemetry data generated at the client computing device in association with the request;
evaluating the telemetry data to detect automation involved in generating the request;
wherein generating the third token occurs only when automation is not detected.
